(19) United States
(12) Patent Application Publication
(10) Pub. No.: US 2024/0291389 A1
(43) Pub. Date: Aug. 29, 2024

(54) LLC RESONANT CONVERSION CIRCUIT, CHARGING DEVICE, ENERGY STORAGE DEVICE, AND POWER-CONSUMING DEVICE

(71) Applicant: Huawei Digital Power Technologies Co., Ltd., Shenzhen (CN)

(72) Inventors: Jiansheng CHEN, Shenzhen (CN); Yang LIU, Shenzhen (CN); Yongfa LI, Shenzhen (CN)

(73) Assignee: Huawei Digital Power Technologies Co., Ltd., Shenzhen (CN)

(21) Appl. No.: 18/654,559

(22) Filed: May 3, 2024

Related U.S. Application Data
(63) Continuation of application No. PCT/CN2022/103844, filed on Jul. 5, 2022.

(30) Foreign Application Priority Data
Nov. 4, 2021 (CN) 202111300517.9

(51) Int. Cl. H02M 3/335; H02J 7/00; H02M 3/00

(52) U.S. Cl. CPC H02M 3/33573; H02M 3/01; H02J 7/00; H02J 2207/20

(57) ABSTRACT

An LLC resonant conversion circuit includes a plurality of harmonic circuits. In each harmonic circuit, a plurality of transformers are electrically connected to each other and are electrically connected to one transformer in another harmonic circuit, so that the harmonic circuits are connected in a crossed manner. In this way, current or voltage of an electrical signal in one harmonic circuit can be distributed to another harmonic circuit. Without adding any component, this achieves the same current value for electrical signals in the harmonic circuits when the harmonic circuits are connected in parallel, and achieves the same voltage value for electrical signals in the harmonic circuits when the harmonic circuits are connected in series. This effectively reduces complexity of a control policy for the entire LLC resonant conversion circuit and also reduces costs of the LLC resonant conversion circuit.

### CROSS-REFERENCE TO RELATED APPLICATIONS

This application is a continuation of International Application No. PCT/CN2022/103844, filed on Jul. 5, 2022, which claims priority to Chinese Patent Application No. 202111300517.9, filed on Nov. 4, 2021. The disclosures of the aforementioned applications are hereby incorporated by reference in their entireties.

### TECHNICAL FIELD

The embodiments relate to the field of power electronics technologies and to an LLC resonant conversion circuit, a charging device, an energy storage device, and a power-consuming device.

### BACKGROUND

With the development of the electric vehicle industry, a battery charging speed is currently one of the main factors that bottleneck the development of electric vehicles. To improve a charging speed of an electric vehicle, a direct current charging pile with a larger power may be configured. However, a power core unit of a charging pile is a charging module. A conventional charging module is usually implemented by using a circuit such as an alternating current/direct current (AC/DC) rectifier unit or a direct current/direct current (DC/DC) rectifier unit. However, as higher requirements are imposed on current conversion efficiency and heat dissipation performance, an existing rectifier circuit cannot meet the requirements. An LLC (which is short for Lr, Lm, and Cr, where Lr is a resonant inductor, Lm is an excitation inductor, and Cr is a resonant capacitor) resonant converter has advantages at least such as high switching frequency, small turn-off losses, high conversion efficiency, low electromagnetic interference noise, and low switching stress, and is therefore widely applied in charging piles.

However, an LLC resonant converter has limited output power, and is generally applied to medium- and low-power products. To achieve higher output power for a charging module, two or more LLC resonant converters may be connected in parallel or in series. However, if a plurality of LLC resonant converters are connected in parallel, current needs to be equalized across the LLC resonant converters. If a plurality of LLC resonant converters are connected in series, voltage needs to be equalized across the LLC resonant converters. To resolve the problem that resonant parameters of output electrical signals are different because of different currents when the LLC resonant converters are connected in parallel or different voltages when the LLC resonant converters are connected in series, a control circuit for current equalization or voltage equalization needs to be added to a circuit that includes the plurality of LLC resonant converters. This undoubtedly increases costs of the entire circuit and results in a complex control policy for the entire circuit.

### SUMMARY

To resolve the foregoing problem, embodiments provide an LLC resonant conversion circuit, a charging device, an energy storage device, and a power-consuming device. Transformers in resonant circuits in the LLC resonant conversion circuit are connected in a crossed manner. In this way, for the entire LLC resonant conversion circuit, autonomous voltage equalization is implemented in series connection and autonomous current equalization is implemented in parallel connection, without the need to add an extra control circuit. This effectively reduces complexity of a control policy for the entire LLC resonant conversion circuit and reduces costs of the LLC resonant conversion circuit.

Therefore, embodiments use the following solutions:

According to a first aspect, an embodiment provides an LLC resonant conversion circuit, including N harmonic circuits, where N is a positive integer greater than or equal to 2. Each harmonic circuit includes a switch circuit, an LC resonant circuit, a transformer circuit, and a rectifier circuit that are electrically connected in sequence. The transformer circuit includes at least three transformers, and each transformer includes a first winding and a second winding. One terminal of a first winding of each of at least two transformers in a transformer circuit in a first harmonic circuit is electrically connected to an LC resonant circuit in the first harmonic circuit, another terminals of the first windings are electrically connected to each other and are electrically connected to one terminal of a first winding of one transformer in a transformer circuit in another harmonic circuit, and the another harmonic circuit is a harmonic circuit other than the first harmonic circuit among the N harmonic circuits. Alternatively, one terminal of a second winding of each of at least two transformers in a transformer circuit in a first harmonic circuit is electrically connected to a rectifier circuit in the first harmonic circuit, and another terminals of the second windings are electrically connected to each other and are electrically connected to one terminal of a second winding of one transformer in a transformer circuit in another harmonic circuit.

In this implementation, the LLC resonant conversion circuit includes a plurality of harmonic circuits. In each harmonic circuit, a plurality of transformers are electrically connected to each other and are electrically connected to one transformer in another harmonic circuit, so that the harmonic circuits are connected in a crossed manner. In this way, current or voltage of an electrical signal in one harmonic circuit can be distributed to another harmonic circuit. Without adding any component, this achieves the same current value for electrical signals in the harmonic circuits when the harmonic circuits are connected in parallel, and achieves the same voltage value for electrical signals in the harmonic circuits when the harmonic circuits are connected in series. This effectively reduces complexity of a control policy for the entire LLC resonant conversion circuit and also reduces costs of the LLC resonant conversion circuit.

In an implementation, when the switch circuits in the harmonic circuits are connected in parallel, one terminal of a first winding of each of at least two transformers in a first transformer circuit is electrically connected to a first LC resonant circuit, another terminals of the first windings of the at least two transformers are electrically connected to each other and are electrically connected to one terminal of a first winding of a first transformer in a second transformer circuit, and another terminal of the first winding of the first transformer is electrically connected to the first LC resonant circuit. One terminal of a first winding of each of at least two transformers other than the first transformer in the second transformer circuit is electrically connected to a second LC resonant circuit, another terminals of the first windings of the at least two transformers other than the first transformer in the second transformer circuit are electrically connected to each other and are electrically connected to one terminal of a first winding of a second transformer in the first transformer circuit, and another terminal of the first winding of the second transformer is electrically connected to the second LC resonant circuit. The first harmonic circuit includes the first LC resonant circuit and the first transformer circuit, the second transformer is a transformer other than the at least two transformers in the first transformer circuit, the another harmonic circuit includes a second harmonic circuit, and the second harmonic circuit includes the second LC resonant circuit and the second transformer circuit.

In this implementation, when the switch circuits in the N harmonic circuits are connected in parallel, one terminal of a primary-side winding of each of at least two transformers in a transformer circuit in a harmonic circuit is electrically connected to an LC resonant circuit, and another terminals of the primary-side windings are electrically connected to each other and are electrically connected to a primary-side winding of one transformer in a transformer circuit in another harmonic circuit. In this way, current values of the two transformers in the harmonic circuit are equal to a current value of one transformer in each of other harmonic circuits. Then, current values of transformers in each harmonic circuit are added up, and the obtained current values that are output by the rectifier circuits in the harmonic circuits are the same. This implements autonomous current distribution for electrical signals in the harmonic circuits, without adding any component.

In an implementation, one terminal of a second winding of each of at least three transformers in the first transformer circuit is electrically connected to a first rectifier circuit, and another terminals of the second windings of the at least three transformers are electrically connected to each other. One terminal of a second winding of each of at least three transformers in the second transformer circuit is electrically connected to a second rectifier circuit, and another terminals of the second windings of the at least three transformers are electrically connected to each other. The first harmonic circuit includes the first rectifier circuit, and the second harmonic circuit includes the second rectifier circuit.

In this implementation, a second winding of each transformer is connected to a rectifier circuit in parallel, so that the transformers output the same current value. This prevents autonomous current distribution of the entire circuit from being affected by different currents on primary-side windings when currents on secondary-side windings of the transformers are different.

In an implementation, the rectifier circuits in the harmonic circuits are connected in series or connected in parallel.

In this implementation, connecting the rectifier circuits in parallel can improve a current value of the entire LLC resonant conversion circuit, and connecting the rectifier circuits in series can improve a voltage value of the entire LLC resonant conversion circuit.

In an implementation, when the switch circuits in the harmonic circuits are connected in series or in parallel, one terminal of a second winding of each of at least two transformers in a first transformer circuit is electrically connected to a first rectifier circuit, another terminals of the second windings of the at least two transformers are electrically connected to each other and are electrically connected to one terminal of a second winding of a first transformer in a second transformer circuit, and another terminal of the second winding of the first transformer is electrically connected to the first rectifier circuit. One terminal of a second winding of each of at least two transformers other than the first transformer in the second transformer circuit is electrically connected to a second rectifier circuit, another terminals of the second windings of the at least two transformers other than the first transformer in the second transformer circuit are electrically connected to each other and are electrically connected to one terminal of a second winding of a second transformer in the first transformer circuit, and another terminal of the second winding of the second transformer is electrically connected to the second rectifier circuit. The first harmonic circuit includes the first transformer circuit and the first rectifier circuit, the second transformer is a transformer other than the at least two transformers in the first transformer circuit, the another harmonic circuit includes a second harmonic circuit, and the second harmonic circuit includes the second transformer circuit and the second rectifier circuit.

In this implementation, when the switch circuits in the N harmonic circuits are connected in parallel, one terminal of a secondary-side winding of each of two transformers in a transformer circuit in a harmonic circuit is electrically connected to a rectifier circuit, and another terminals of the secondary-side windings are electrically connected to each other and are electrically connected to a secondary-side winding of one transformer in a transformer circuit in another harmonic circuit. In this way, current values of the two transformers in the harmonic circuit are equal to a current value of one transformer in each of other harmonic circuits. Then, current values of transformers in each harmonic circuit are added up, and obtained current values that are output by the rectifier circuits in the harmonic circuits are the same. This implements autonomous current distribution for electrical signals in the harmonic circuits, without adding any component.

When the switch circuits in the N harmonic circuits are connected in series, one terminal of a secondary-side winding of each of two transformers in a transformer circuit in a harmonic circuit is electrically connected to a rectifier circuit, and another terminals of the second-side windings are electrically connected to each other and are electrically connected to a secondary-side winding of one transformer in a transformer circuit in another harmonic circuit. In this way, voltage values at two terminals of the two transformers in the harmonic circuit are equal to voltage values at two terminals of one transformer in each of other harmonic circuits. Then, voltage values of transformers in each harmonic circuit are added up, and obtained voltage values that are output by the rectifier circuits in the harmonic circuits are the same. This implements autonomous voltage distribution for electrical signals in the harmonic circuits, without adding any component.

In an implementation, one terminal of a first winding of each of at least three transformers in the first transformer circuit is electrically connected to a first LC resonant circuit, and another terminals of the first windings of the at least three transformers are electrically connected to each other. One terminal of a first winding of each of at least three transformers in the second transformer circuit is electrically connected to a second LC resonant circuit, and another terminals of the first windings of the at least three transformers are electrically connected to each other. The first harmonic circuit includes the first LC resonant circuit, and the second harmonic circuit includes the second LC resonant circuit.

In this implementation, a first winding of each transformer is connected to an LC resonant circuit in parallel, so that the transformers input the same current value and the same voltage value to second windings. This prevents autonomous current distribution or autonomous voltage distribution of the entire circuit from being affected by different currents or voltages on the second windings when currents or voltages on the first windings of the transformers are different.

In an implementation, the rectifier circuits in the harmonic circuits are connected in parallel.

In this implementation, the rectifier circuits are connected in parallel. This can improve a current value of the entire LLC resonant conversion circuit.

In an implementation, the transformers in each transformer circuit are the same.

In this implementation, the transformers in the transformer circuits are the same. This ensures that the transformers input the same voltage value and the same current value to secondary sides.

In an implementation, the at least three transformers in each transformer circuit share an iron core.

In this implementation, the transformers share one iron core. This avoids different impedances between iron cores of different transformers, so that the transformers input the same voltage value and the same current value to secondary sides.

According to a second aspect, an embodiment provides a two-way three-phase LLC resonant conversion circuit, including a first harmonic circuit and a second harmonic circuit. The first harmonic circuit includes a first switch circuit, a first LC resonant circuit, a first transformer circuit, and a first rectifier circuit that are electrically connected in sequence. The second harmonic circuit includes a second switch circuit, a second LC resonant circuit, a second transformer circuit, and a second rectifier circuit that are electrically connected in sequence. The first switch circuit and the second switch circuit are connected in series. Each switch circuit includes three output ports, each LC resonant circuit includes three resonant inductors and three resonant capacitors, each resonant inductor is connected in series to one resonant capacitor, each transformer circuit includes three transformers, each transformer includes a first winding and a second winding, and each rectifier circuit includes three input ports. Three output ports of the first switch circuit are respectively connected in series to three resonant inductors and three resonant capacitors in the first LC resonant circuit in sequence. Each of two of the three resonant capacitors is electrically connected to one terminal of a first winding of one of two of three transformers in the first transformer circuit in a one-to-one correspondence, and another terminals of the first windings of the two of the three transformers in the first transformer circuit are electrically connected to each other and are electrically connected to one terminal of a first winding of one of three transformers in the second transformer circuit. One terminal of a first winding of the other transformer of the three transformers in the first transformer circuit is electrically connected to one of three resonant capacitors in the second LC resonant circuit, and another terminal of the first winding of the other transformer of the three transformers in the first transformer circuit is electrically connected to one terminal of a first winding of each of the other two of the three transformers in the second transformer circuit. One terminal of a second winding of each of the three transformers in the first transformer circuit is electrically connected to one of three input ports of the first rectifier circuit in a one-to-one correspondence, and another terminals of the second windings of the three transformers in the first transformer circuit are electrically connected to each other. Three output ports of the second switch circuit are respectively connected in series to three resonant inductors and the three resonant capacitors in the second LC resonant circuit in sequence, and the other two of the three resonant capacitors in the second LC resonant circuit are respectively electrically connected to another terminals of the first windings of the other two of the three transformers in the second transformer circuit. One terminal of a second winding of each of the three transformers in the second transformer circuit is electrically connected to one of three input ports of the second rectifier circuit in a one-to-one correspondence, and another terminals of the second windings of the three transformers in the second transformer circuit are electrically connected to each other.

According to a third aspect, an embodiment provides a two-way three-phase LLC resonant conversion circuit, including a first harmonic circuit and a second harmonic circuit. The first harmonic circuit includes a first switch circuit, a first LC resonant circuit, a first transformer circuit, and a first rectifier circuit that are electrically connected in sequence. The second harmonic circuit includes a second switch circuit, a second LC resonant circuit, a second transformer circuit, and a second rectifier circuit that are electrically connected in sequence. Each switch circuit includes three output ports, each LC resonant circuit includes three resonant inductors and three resonant capacitors, each resonant inductor is connected in series to one resonant capacitor, each transformer circuit includes three transformers, each transformer includes a first winding and a second winding, and each rectifier circuit includes three input ports. Three output ports of the first switch circuit are respectively connected in series to three resonant inductors and three resonant capacitors in the first LC resonant circuit in sequence. Each of the three resonant capacitors is electrically connected to one terminal of a first winding of one of three transformers in the first transformer circuit in a one-to-one correspondence, and another terminals of the first windings of the three transformers in the first transformer circuit are electrically connected to each other. One terminal of a second winding of each of two of the three transformers in the first transformer circuit is electrically connected to one of two of three input ports of the first rectifier circuit in a one-to-one correspondence, and another terminals of the second windings of the two of the three transformers in the first transformer circuit are electrically connected to each other and are electrically connected to one terminal of a second winding of one of three transformers in the second transformer circuit. One terminal of a second winding of the other transformer of the three transformers in the first transformer circuit is electrically connected to one of three input ports of the second rectifier circuit, and another terminal of the second winding of the other transformer of the three transformers in the first transformer circuit is electrically connected to one terminal of a second winding of each of the other two of the three transformers in the second transformer circuit. Three output ports of the second switch circuit are respectively connected in series to three resonant inductors and three resonant capacitors in the second LC resonant circuit in sequence, each of the three resonant capacitors is electrically connected to one terminal of a first winding of one of the three transformers in the second transformer circuit in a one-to-one correspondence, and another terminals of the first windings of the three transformers in the second transformer circuit are electrically connected to each other. Another terminal of the second winding of the one of the three transformers in the second transformer circuit is electrically connected to one of the three input ports of the first rectifier circuit, and another terminals of the second windings of the other two of the three transformers in the second transformer circuit are respectively electrically connected to the other two of the three input ports of the second rectifier circuit.

According to a fourth aspect, an embodiment provides a charging device, including at least one LLC resonant conversion circuit according to the possible implementations of the first aspect.

According to a fifth aspect, an embodiment provides an energy storage device, including a battery and at least one LLC resonant conversion circuit according to the possible implementations of the first aspect. The LLC resonant conversion circuit is electrically connected to the battery and is configured to process an electrical signal to be input to the battery, and input a processed electrical signal to the battery.

According to a sixth aspect, an embodiment provides a power-consuming device, including at least one electricity consumption component and at least one LLC resonant conversion circuit according to the possible implementations of the first aspect. The at least one LLC resonant conversion circuit is electrically connected to the at least one electricity consumption component and is configured to process an electrical signal to be input to the at least one electricity consumption component, and input a processed electrical signal to the at least one electricity consumption component.

### BRIEF DESCRIPTION OF THE DRAWINGS

The following briefly describes the accompanying drawings that need to be used in the descriptions of embodiments or a conventional technology.

FIG. 1 is a schematic diagram of an architecture of an LLC resonant conversion circuit according to an embodiment;

FIG. 2 is a schematic circuit diagram of a first two-way three-phase LLC resonant conversion circuit in which switch circuits are connected in parallel according to an embodiment;

FIG. 3 is a schematic circuit diagram of a second two-way three-phase LLC resonant conversion circuit in which switch circuits are connected in parallel according to an embodiment;

FIG. 4 is a schematic circuit diagram of a third two-way three-phase LLC resonant conversion circuit in which switch circuits are connected in parallel according to an embodiment;

FIG. 5 is a schematic circuit diagram of an N-way three-phase LLC resonant conversion circuit in which switch circuits are connected in parallel according to an embodiment;

FIG. 6 is a schematic circuit diagram of a two-way three-phase LLC resonant conversion circuit in which switch circuits are connected in series according to an embodiment; and

FIG. 7 is a schematic circuit diagram of an N-way three-phase LLC resonant conversion circuit in which switch circuits are connected in series according to an embodiment.

### DETAILED DESCRIPTION OF EMBODIMENTS

The following describes the solutions in embodiments with reference to the accompanying drawings in embodiments.

The term “and/or” in the embodiments describes an association relationship between associated objects and represents that three relationships may exist. For example, A and/or B may represent the following three cases: only A exists, both A and B exist, and only B exists. The character “/” indicates an “or” relationship between the associated objects. For example, A/B indicates A or B.

In the embodiments, the terms “first”, “second”, and the like are intended to distinguish between different objects, but do not indicate a particular order of the objects. For example, a first response message, a second response message, and the like are used to distinguish between different response messages, but do not indicate a particular order of the response messages.

In embodiments, the word “example” or “for example” is used to represent an example, an illustration, or a description. Any embodiment or design scheme described as “example” or “for example” in embodiments should not be explained as being more preferred or more advantageous than another embodiment or design scheme. Exactly, use of the word such as “example” or “for example” is intended to present a relative concept in a specific manner.

In the descriptions of embodiments, unless otherwise specified, “a plurality of” means two or more. For example, a plurality of processing units means two or more processing units, and a plurality of elements means two or more elements.

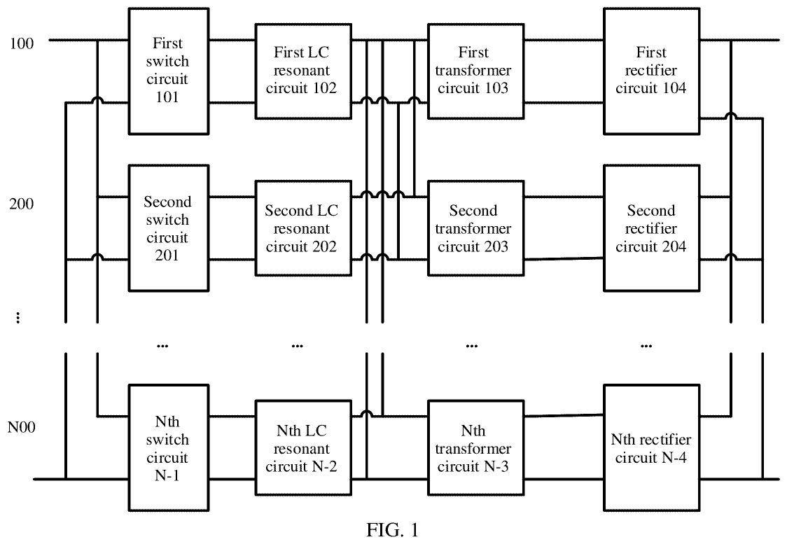

FIG. 1 is a schematic diagram of an architecture of an LLC resonant conversion circuit according to an embodiment. As shown in FIG. 1, the LLC resonant conversion circuit in the embodiments may include N harmonic circuits (100, 200, . . . , and N00), where N is a positive integer greater than or equal to 2. Each harmonic circuit (100, 200, . . . , or N00) includes a switch circuit (101, 201, . . . , or N01), an LC resonant circuit (102, 202, . . . , or N02), a transformer circuit (103, 203, . . . , or N03), and a rectifier circuit (104, 204, . . . , or N04).

In each harmonic circuit (100, 200, . . . , or N00), the switch circuit, the LC resonant circuit, the transformer circuit, and the rectifier circuit are electrically connected in sequence. In this way, after an electrical signal that is input by an external circuit passes through the switch circuit, the LC resonant circuit, the transformer circuit, and the rectifier circuit in sequence, a current value or a voltage value of the input electrical signal is increased, thereby increasing power of the input electrical signal.

The harmonic circuits (100, 200, . . . , and N00) may be connected in parallel or in series. For example, for the switch circuits (101, 201, . . . , and N01) in the harmonic circuits (100, 200, . . . , and N00), positive electrodes of the switch circuits may be electrically connected together, and negative electrodes of the switch circuits may be electrically connected together. In this way, the harmonic circuits are connected together in parallel. Alternatively, a positive electrode of a switch circuit may be electrically connected to a negative electrode of a switch circuit on one side, and a negative electrode of the switch circuit may be electrically connected to a positive electrode of a switch circuit on another side, and so on. In this way, the harmonic circuits are connected together in series.

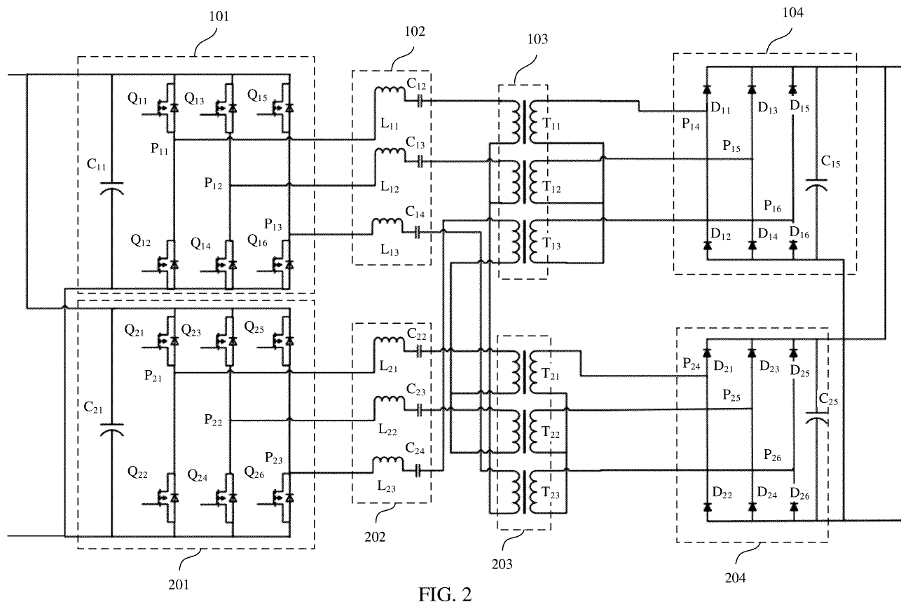

A communicative connection can be established between the switch circuit (101, 201, . . . , or N−1) and an external controller. A control command sent by the controller is received, to control whether to connect an electrical signal that is input to a harmonic circuit and whether to convert the input direct current electrical signal into a square wave electrical signal. For example, as shown in FIG. 2, the switch circuit 101 is a three-phase switch circuit, and may include a first switching transistor Q₁₁, a second switching transistor Q₁₂, a third switching transistor Q₁₃, a fourth switching transistor Q₁₄, a fifth switching transistor Q₁₅, a sixth switching transistor Q₁₆, and an input capacitor C₁₁. The first switching transistor Q₁₁ and the second switching transistor Q₁₂ are connected in series, and the first switching transistor Q₁₁ and the second switching transistor Q₁₂ are electrically connected to obtain an output port P₁₁, which may be electrically connected to the LC resonant circuit 102. The third switching transistor Q₁₃ and the fourth switching transistor Q₁₄ are connected in series, and the third switching transistor Q₁₃ and the fourth switching transistor Q₁₄ are electrically connected to obtain an output port P₁₂, which may be electrically connected to the LC resonant circuit 102. The fifth switching transistor Qis and the sixth switching transistor Q₁₆ are connected in series, and the fifth switching transistor Qis and the sixth switching transistor Q₁₆ are electrically connected to obtain an output port P₁₃, which may be electrically connected to the LC resonant circuit 102. Each group of switching transistors and the input capacitor C₁₁ are connected in parallel. The input capacitor C₁₁ performs filtering on an electrical signal that is input from an outside. Then, an upper-part switching transistor and a lower-part switching transistor in each group of switching transistors are controlled to alternately turn on, to convert the direct current electrical signal that has undergone filtering into a square wave electrical signal, so that the three output ports P may output three square wave electrical signals.

Optionally, a switching transistor in a switch circuit may include one or more metal-oxide-semiconductor field-effect transistors (MOSFET). A controller is connected to a gate of each MOS to control whether to turn on the gate of each MOS, to turn on or turn off the switching transistor.

In the embodiments, the switch circuit 101 being a three-phase switch circuit is merely used as an example. The switch circuit 101 may alternatively be a two-phase switch circuit or the like based on an actual product requirement. This is not limited. In addition, a circuit structure of another switch circuit (201, . . . , or N01) is generally the same as a circuit structure of the switch circuit 101, and may be different from the circuit structure of the switch circuit 101 based on an actual product requirement. This is not limited.

The LC resonant circuit (102, 202, . . . , or N02) may be connected in series to the transformer circuit (103, 203, . . . , or N03), to form an LLC resonator. A primary-side winding (which is a coil winding on a side that is electrically connected to an LC resonant circuit) of at least one transformer in each transformer circuit may be electrically connected in a crossed manner with a primary-side winding of at least one transformer in another transformer circuit. Alternatively, a secondary-side winding (which is a coil winding on a side that is electrically connected to a rectifier circuit) of at least one transformer in each transformer circuit may be electrically connected in a crossed manner with a secondary-side winding of at least one transformer in another transformer circuit. In this way, current of an electrical signal on a harmonic circuit may be distributed to another one or more harmonic circuits. This implements current equalization for an electrical signal in each harmonic circuit when the harmonic circuits are connected in parallel, and implements voltage equalization for the electrical signal in each harmonic circuit when the harmonic circuits are connected in series.

For example, as shown in FIG. 2, the LC resonant circuit 102 includes three resonant inductors (L₁₁, L₁₂, and L₁₃) and three resonant capacitors (C₁₂, C₁₃, and C₁₄). The transformer circuit 103 includes three transformers (T₁₁, T₁₂, and T₁₃). The resonant inductor Lu and the resonant capacitor C₁₂ are connected in series, and another terminal of the resonant inductor L₁₁ is electrically connected to the output port P₁₁, to form an LC resonator. The resonant inductor L₁₂ and the resonant capacitor C₁₃ are connected in series, and another terminal of the resonant inductor L₁₂ is electrically connected to the output port P₁₂, to form an LC resonator. The resonant inductor L₁₃ and the resonant capacitor C₁₄ are connected in series, and another terminal of the resonant inductor L₁₃ is electrically connected to the output port P₁₃, to form an LC resonator.

A primary-side winding of each transformer T in the transformer circuit 103 may be connected in series to a resonant capacitor C in the LC resonant circuit 102, or may be connected in series to a resonant capacitor C in another harmonic circuit (202, . . . , or N02), to form an LLC resonator. A circuit obtained by connecting a resonant inductor L and a resonant capacitor C in each group in series in a harmonic circuit may be connected in series to primary-side windings of transformers in different harmonic circuits. In this way, when the switch circuits are connected in parallel, current in each harmonic circuit is evenly distributed to different harmonic circuits, so that current values of electrical signals output by the harmonic circuits are the same. A secondary-side winding of each transformer T in each transformer circuit may be connected in series to a rectifier circuit in a corresponding harmonic circuit.

A secondary-side winding of each transformer T in the transformer circuit 103 may be connected in series to the rectifier circuit 104, or may be connected in series to another rectifier circuit (204, . . . , or N04). In this way, when the switch circuits are connected in parallel, current in each harmonic circuit is evenly distributed to different harmonic circuits, so that current values of electrical signals output by the harmonic circuits are the same. When the switch circuits are connected in series, voltage in each harmonic circuit is evenly distributed to different harmonic circuits, so that voltage values at two terminals of all the transformer circuits are the same. A primary-side winding of each transformer T in each transformer circuit may be connected in series with an LC resonant circuit in a corresponding harmonic circuit.

In the embodiments, in each harmonic circuit (100, 200, . . . , or N00), a quantity of LC resonant sets in an LC resonant circuit is the same as a quantity of input ports P of a switch circuit, and a quantity of transformers in a transformer circuit is the same as the quantity of LC resonators in the LC resonant circuit.

Transformers in a transformer circuit may use identical transformers, such as transformers with the same impedance and the same quantity of turns for a primary-side winding and a secondary-side winding. Optionally, a transformer is not limited to a structure shown in FIG. 2, in which a quantity of primary-side windings and a quantity of secondary-side windings are in a 1:1 relationship. Alternatively, a quantity of primary-side windings and a quantity of secondary-side windings may be in a 1:x, x:1, or x:y relationship, where x and y are positive integer greater than or equal to 1. This is not limited.

A rectifier circuit (104, 204, . . . , or N−4) is connected in series to a transformer circuit, to convert an alternating current electrical signal input by the transformer circuit into a direct current electrical signal. For example, as shown in FIG. 2, the rectifier circuit 104 includes a first diode D₁₁, a second diode D₁₂, a third diode D₁₃, a fourth diode D₁₄, a fifth diode D₁₅, a diode D₁₆, and an output capacitor C₁₆. The first diode Du and the second diode D₁₂ are connected in series, and the first diode Du and the second diode D₁₂ are electrically connected to obtain an input port P₁₄, which may be electrically connected to a secondary-side winding of one or more transformers. The third diode D₁₃ and the fourth diode D₁₄ are connected in series, and the third diode D₁₃ and the fourth diode D₁₄ are electrically connected to obtain an input port P₁₅, which may be electrically connected to a secondary-side winding of one or more transformers. The fifth diode Dis and the diode D₁₆ are connected in series, and the fifth diode Dis and the diode D₁₆ are electrically connected to obtain an input port P₁₆, which may be electrically connected to a secondary-side winding of one or more transformers. Each group of diodes is connected in parallel to the output capacitor C₁₆. When an alternating current electrical signal is separately input to the groups of diodes through the three output ports P, the alternating current electrical signal flows out through upper-part diodes or lower-part diodes in the groups of diodes, to convert the alternating current electrical signal into a direct current electrical signal. The direct current electrical signal is then filtered by the input capacitor Cn, to obtain a filtered direct current electrical signal.

In the embodiments, the rectifier circuits (104, 204, . . . , and N−4) may be connected together in parallel. Current values of electrical signals in the rectifier circuits are aggregated to increase a current value of an output electrical signal. The rectifier circuits in the harmonic circuits may alternatively be connected together in series. In this way, voltage values of electrical signals in the rectifier circuits are connected in series to increase a voltage value of an output electrical signal.

In the embodiments, in each harmonic circuit (100, 200, . . . , or N00), a quantity of diode groups that are connected in parallel in a rectifier circuit is the same as a quantity of input ports P of a switch circuit, and also the same as a quantity of transformers in a transformer circuit.

The LLC resonant conversion circuit in this embodiment includes a plurality of harmonic circuits. In each harmonic circuit, a plurality of transformers are electrically connected to each other and are electrically connected to one transformer in another harmonic circuit, so that the harmonic circuits are connected in a crossed manner. In this way, current or voltage of an electrical signal in one harmonic circuit can be distributed to another harmonic circuit. Without adding any component, this achieves the same current value for electrical signals in the harmonic circuits when the harmonic circuits are connected in parallel, and achieves the same voltage value for electrical signals in the harmonic circuits when the harmonic circuits are connected in series. This effectively reduces complexity of a control policy for the entire LLC resonant conversion circuit and also reduces costs of the LLC resonant conversion circuit.

The following describes solutions in the embodiments based on different LLC resonant conversion circuits.

With reference to the two-way three-phase LLC resonant conversion circuit shown in FIG. 2, the circuit includes a first harmonic circuit 100 and a second harmonic circuit 200. The first harmonic circuit 100 includes a first switch circuit 101, a first LC resonant circuit 102, a first transformer circuit 103, and a first rectifier circuit 104. The second harmonic circuit 200 includes a second switch circuit 201, a second LC resonant circuit 202, a second transformer circuit 203, and a second rectifier circuit 204. The first switch circuit 101 and the second switch circuit 201 are connected in parallel, and the first rectifier circuit 104 and the second rectifier circuit 204 are connected in parallel.

When the first switch circuit 101 and the second switch circuit 201 are connected in parallel, voltage values of electrical signals that are input to the first harmonic circuit 100 and the second harmonic circuit 200 are the same. However, current values of the electrical signals that pass through the first harmonic circuit 100 and the second harmonic circuit 200 may be different, so that resonant parameters of electrical signals that are output by the first rectifier circuit 104 and the second rectifier circuit 204 are different. As a result, an electrical signal that is output by the two-way three-phase LLC resonant conversion circuit cannot provide an electrical signal for a power-consuming device.

In the embodiments, to achieve the same current value for the electrical signals that pass through the first harmonic circuit 100 and the second harmonic circuit 200, two LC resonant circuits may be connected in a crossed manner to a primary-side winding of each transformer in two transformer circuits. A specific connection manner is as follows.

In the first transformer circuit 103, one terminal of a transformer T₁₁ is connected in series to a resonant capacitor C₁₂ in the first LC resonant circuit 102, one terminal of a transformer T₁₂ is connected in series to a harmonic capacitor C₁₃ in the first LC resonant circuit 102, and another terminal of the transformer T₁₁ and another terminal of the transformer T₁₂ are electrically connected to each other and are electrically connected to one terminal of a transformer T₂₃ in the second transformer circuit 203. One terminal of a transformer T₁₃ is connected in series to a harmonic capacitor C₂₄ in the second LC resonant circuit 202, and another terminal of the transformer T₁₃ is electrically connected to one terminal of a transformer T₂₁ in the second transformer circuit 203 and one terminal of a transformer T₂₂. Another terminal of the transformer T₂₁ in the second transformer circuit 203 is connected in series to a harmonic capacitor C₂₂ in the second LC resonant circuit 202, and another terminal of the transformer T₂₂ is connected in series to a harmonic capacitor C₂₃ in the second LC resonant circuit 202.

A connection manner between two rectifier circuits and a secondary-side winding of each transformer in two transformer circuits may be as follows.

In the first transformer circuit 103, one terminal of a transformer T₁₁ is connected in series to an input port P₁₄ of the first rectifier circuit 104, one terminal of a transformer T₁₂ is connected in series to an input port P₁₅ of the first rectifier circuit 104, one terminal of a transformer T₁₃ is connected in series to an input port P₁₆ of the first rectifier circuit 104, and another terminal of the transformer T₁₁, another terminal of the transformer T₁₂, and another terminal of the transformer T₁₃ are electrically connected to each other. In the second transformer circuit 203, one terminal of a transformer T₂₁ is connected in series to an input port P₂₄ of the second rectifier circuit 204, one terminal of a transformer T₂₂ is connected in series to an input port P₂₅ of the second rectifier circuit 204, one terminal of a transformer T₂₃ is connected in series to an input port P₂₆ of the second rectifier circuit 204, and another terminal of the transformer T₂₁, another terminal of the transformer T₂₂, and another terminal of the transformer T₂₃ are electrically connected to each other. After being extended, a line between a rectifier circuit and a secondary-side winding of a transformer assumes a “Y” shape. Therefore, this connection manner may be referred to as a Y-shaped connection manner.

Denote a current of a primary-side winding of the transformer T₁₁ as I_{AT11} (where a current value is a vector here and hereinafter), a current of a secondary-side winding of the transformer T₁₁ as I_{BT11}, a current of a primary-side winding of the transformer T₁₂ as I_{AT12}, a current of a secondary-side winding of the transformer T₁₂ as I_{BT12}, a current of a primary-side winding of the transformer T₁₃ as I_{AT13}, a current of a secondary-side winding of the transformer T₁₃ as I_{BT13}, a current of a primary-side winding of the transformer T₂₁ as I_{AT21}, a current of a secondary-side winding of the transformer T₂₁ as I_{BT21}, a current of a primary-side winding of the transformer T₂₂ as I_{AT22}, a current of a secondary-side winding of the transformer T₂₂ as I_{BT22}, a current of a primary-side winding of the transformer T₂₃ as I_{AT23}, and a current of a secondary-side winding of the transformer T₂₃ as I_{BT23}. I_{AT11}, I_{AT12}, and I_{AT13} are of different phases, and I_{AT11} and I_{BT11} are of the same phases. A relationship between other currents is obtained by analogy. Optionally, a phase difference between I_{AT11}, I_{AT12}, and I_{AT13} is 120°.

For primary-side windings of two transformer circuits, the transformer T₁₁ and the transformer T₁₂ are electrically connected to each other and are electrically connected to the transformer T₂₃. Therefore, I_{AT11}+I_{AT12}=I_{AT23}. The transformer T₂₁ and the transformer T₂₂ are electrically connected to each other and are electrically connected to the transformer T₁₃. Therefore, I_{AT21}+I_{AT22}=I_{AT13}. I_{AT11}, I_{AT12}, and I_{AT23} are of different phases, and I_{AT21}, I_{AT22}, and I_{AT13} are also of different phases.

For secondary-side windings of transformers in the first transformer circuit 103, the transformer T₁₁, the transformer T₁₂, and the transformer T₁₃ are electrically connected to each other. Therefore, for the first harmonic circuit 100, a total current I₁=I_{BT11}+I_{BT12}+I_{BT13}=n·I_{AT11}+n·I_{AT12}+n·I_{AT13}. Similarly, for secondary-side windings of transformers in the second transformer circuit 203, in the second harmonic circuit 200, 12=I_{BT21}+I_{BT22}+I_{BT223}=n·I_{AT21}+n·I_{AT22}+n·I_{AT23}. When a quantity of turns of a primary-side winding and that of a secondary-side winding are the same in each transformer, I₁=I₂. In this case, current values of the first harmonic circuit 100 and the second harmonic circuit 200 are the same, thereby implementing autonomous current equalization among the harmonic circuits in the two-way three-phase LLC resonant conversion circuit.

In this embodiment, two transformers in the first transformer circuit are electrically connected to each other, and then electrically connected to one transformer in the second transformer circuit, so that currents of the two transformers in the first transformer circuit are equal to a current of the one transformer in the second transformer circuit. Similarly, two transformers in the second transformer circuit are electrically connected to each other, and then electrically connected to one transformer in the first transformer circuit, so that currents of the two transformers in the second transformer circuit are equal to a current of the one transformer in the first transformer circuit. In this way, a current of the first transformer circuit is equal to a current of the second transformer circuit, thereby implementing autonomous current equalization among circuits in the two-way three-phases LLC resonant conversion circuit.

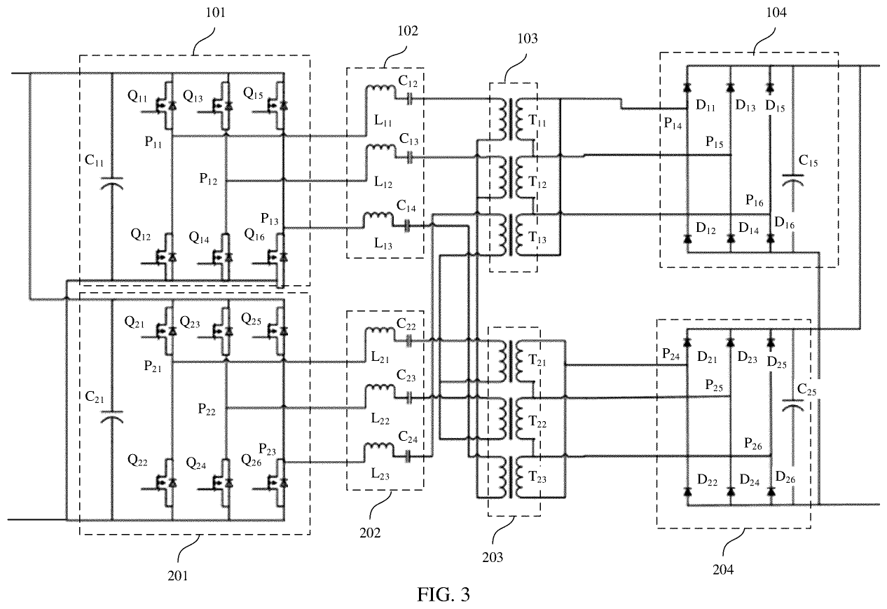

For example, as shown in FIG. 3, a connection manner between two rectifier circuits and a secondary-side winding of each transformer in two transformer circuits may alternatively be as follows:

In the first transformer circuit 103, one terminal of the transformer T₁₁, one terminal of the transformer T₁₂, and one terminal of the transformer T₁₃ are electrically connected to each other, another terminal of the transformer T₁₁ is electrically connected to an input port P₁₄ of the first rectifier circuit 104, another terminal of the transformer T₁₂ is electrically connected to an input port P₁₅ of the first rectifier circuit 104, another terminal of the transformer T₁₃ is electrically connected to an input port P₁₆ of the first rectifier circuit 104. In the second transformer circuit 203, one terminal of the transformer T₂₁, one terminal of the transformer T₂₂, and one terminal of the transformer T₂₃ are connected together in parallel, another terminal of the transformer T₂₁ is electrically connected to an input port P₂₄ of the second rectifier circuit 204, another terminal of the transformer T₂₂ is electrically connected to an input port P₂₅ of the second rectifier circuit 204, and another terminal of the transformer T₂₃ is electrically connected to an input port P₂₆ of the second rectifier circuit 204. After being extended, a line between an LC resonant circuit and a transformer assumes a “A” shape. Therefore, this connection manner may be referred to as a A-shaped connection manner.

For secondary-side windings of transformers in the first transformer circuit 103, the transformer T₁₁, the transformer T₁₂, and the transformer T₁₃ are electrically connected to each other. Therefore, for the first harmonic circuit 100, a total current I₁=I_{BT11}+I_{BT12}+I_{BT13}=n·I_{AT11}+n·I_{AT12}+n·I_{AT13}. Similarly, for secondary-side windings of transformers in the second transformer circuit 203, in the second harmonic circuit 200, 12=I_{BT21}+I_{BT22}+I_{BT223}=n·I_{AT21}+n·I_{AT22}+n·I_{AT23}. When a quantity of turns of a primary-side winding and that of a secondary-side winding are the same in each transformer, I₁=I₂. In this case, current values of the harmonic circuits are the same, thereby implementing autonomous current equalization among the harmonic circuits in the two-way three-phase LLC resonant conversion circuit.

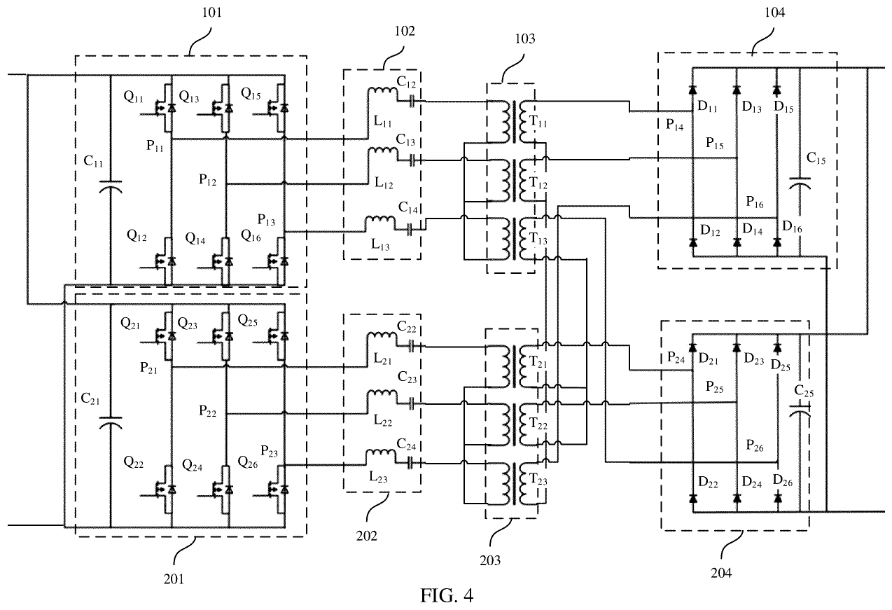

With reference to FIG. 4, to achieve the same current value for the electrical signals that pass through the first harmonic circuit 100 and the second harmonic circuit 200, two rectifier circuits may be connected in a crossed manner to a secondary-side winding of each transformer in two transformer circuits. A specific connection manner is as follows:

In the first transformer circuit 103, one terminal of a transformer T₁₁ is electrically connected to an input port P₁₄ of the first rectifier circuit 104, one terminal of a transformer T₁₂ is electrically connected to an input port P₁₅ of the first rectifier circuit 104, another terminal of the transformer T₁₁ and another terminal of the transformer T₁₂ are electrically connected to each other and electrically connected to one terminal of a transformer T₂₃ in the second transformer circuit 203. One terminal of a transformer T₁₃ is electrically connected to an input port P₂₆ of the second rectifier circuit 204, and another terminal of the transformer T₁₃ is electrically connected to one terminal of a transformer T₂₁ and one terminal of a transformer T₂₂ in the second transformer circuit 203. Another terminal of the transformer T₂₁ in the second transformer circuit 203 is electrically connected to an input port P₂₄ of the second rectifier circuit 204, and another terminal of the transformer T₂₂ is electrically connected to an input port P₂₅ of the second rectifier circuit 204.

A connection manner between two rectifier circuits and a primary-side winding of each transformer in two transformer circuits may be a Y-shaped connection manner. The following provides an example.

In the first transformer circuit 103, one terminal of a transformer T₁₁ is connected in series to a harmonic capacitor C₁₂ in the first LC resonant circuit 102, one terminal of a transformer T₁₂ is connected in series to a harmonic capacitor C₁₃ in the first LC resonant circuit 102, one terminal of a transformer T₁₃ is connected in series to a harmonic capacitor C₁₄ in the first LC resonant circuit 102, and another terminal of the transformer T₁₁, another terminal of the transformer T₁₂, and another terminal of the transformer T₁₃ are electrically connected to each other. In the second transformer circuit 203, one terminal of a transformer T₂₁ is connected in series to a harmonic capacitor C₂₂ in the second LC resonant circuit 202, one terminal of a transformer T₂₂ is connected in series to a harmonic capacitor C₂₃ in the second LC resonant circuit 202, one terminal of a transformer T₂₃ is connected in series to a harmonic capacitor C₂₄ in the second LC resonant circuit 202, and another terminal of the transformer T₂₁, another terminal of the transformer T₂₂, and another terminal of the transformer T₂₃ are electrically connected to each other.

For secondary-side windings of two transformer circuits, the transformer T₁₁ and the transformer T₁₂ are electrically connected to each other and are electrically connected to the transformer T₂₃. Therefore, I_{BT11}+I_{BT12}=I_{BT23}. The transformer T₂₁ and the transformer T₂₂ are electrically connected to each other and are electrically connected to the transformer T₁₃. Therefore, I_{BT21}+I_{BT22}=I_{BT13}. For the first harmonic circuit 100, a total current I₁=I_{BT11}+I_{BT12}+I_{BT13}. For the second harmonic circuit 200, a total current I₂=I_{BT21}+I_{BT22}+I_{BT23}. Therefore, I₁=I₂. In this case, current values of the harmonic circuits are the same, thereby implementing autonomous current equalization among the harmonic circuits in the two-way three-phase LLC resonant conversion circuit. I_{BT11}, I_{BT12}, and I_{BT23} are of different phases, and I_{BT21}, I_{BT22}, and I_{BT13} are also of different phases.

In the embodiments, as an example in FIG. 4, a connection manner between a rectifier circuit and a secondary-side winding of a transformer is a Y-shaped connection manner. Alternatively, the connection manner may be a A-shaped connection manner. This is not limited. For a specific connection structure thereof, refer to FIG. 3 and solutions corresponding to FIG. 3. Details are not described herein again.

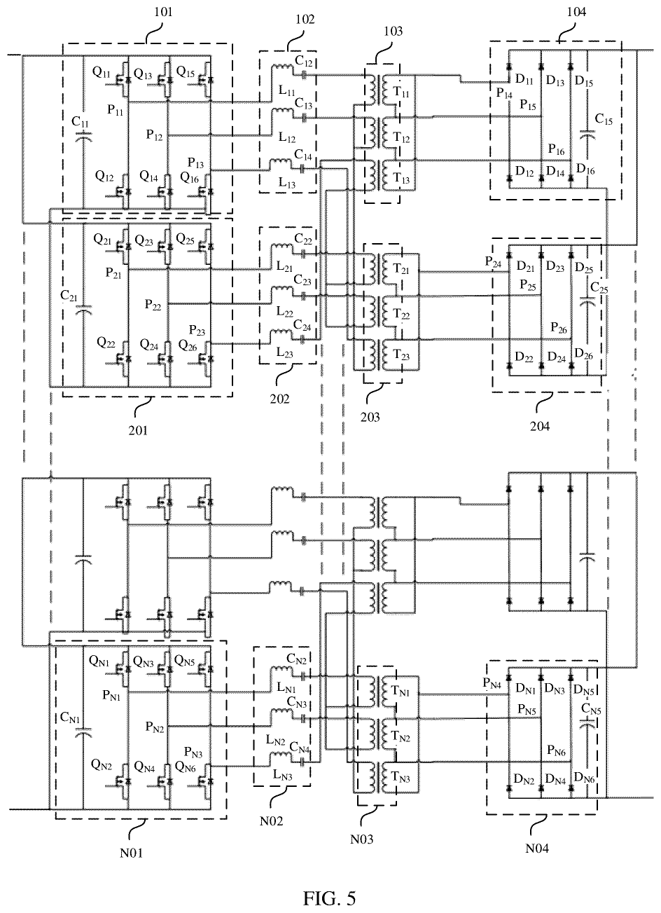

With reference to an N-way three-phase LLC resonant conversion circuit shown in FIG. 5, the circuit includes N harmonic circuits (100, 200, . . . , and N00). To achieve the same current value for electrical signals that pass through a first harmonic circuit 100 and a second harmonic circuit 200, two LC resonant circuits may be connected in a crossed manner to a primary-side winding of each transformer in two transformer circuits. A specific connection manner is as follows.

In a first transformer circuit 103, one terminal of a transformer T₁₁ is connected in series to a harmonic capacitor C₁₂ in a first LC resonant circuit 102, one terminal of a transformer T₁₂ is connected in series to a harmonic capacitor C₁₃ in the first LC resonant circuit 102, and another terminal of the transformer T₁₁ and another terminal of the transformer T₁₂ are electrically connected to each other and then electrically connected to one terminal of a transformer T₂₃ in a second transformer circuit 203, . . . , and one terminal of a transformer T_{N3} in an Nth transformer circuit N03 in sequence. In this way, each harmonic circuit includes a current of I_{BT11}+I_{BT12}. Two terminals of a transformer T₁₃ in the first transformer circuit 103 are both electrically connected to a node obtained by electrically connecting a transformer T₂₁ and a transformer T₂₂ in the second transformer circuit 203, . . . , and a node obtained by electrically connecting a transformer T_{N1} and a transformer T_{N2} in the Nth transformer circuit N03. In this way, each harmonic circuit includes a current of I_{BT21}+I_{BT22}+ . . . +I_{BTN1}+I_{BTN2}. Therefore, a current of each harmonic circuit is I=I_{BT11}+I_{BT12}+I_{BT21}+I_{BT22}+ . . . +I_{BTN1}+I_{BTN2}, such as the current values of the harmonic circuits are the same, thereby implementing autonomous current equalization among the harmonic circuits in the N-way three-phase LLC resonant conversion circuit.

In the embodiments, as an example in FIG. 5, a connection manner between a rectifier circuit and a secondary-side winding of a transformer is a Y-shaped connection manner. Alternatively, the connection manner may be a A-shaped connection manner. This is not limited. For a specific connection structure thereof, refer to FIG. 3 and solutions corresponding to FIG. 3. Details are not described herein again.

In the embodiments, as an example in FIG. 5, an LC resonant circuit and a primary-side winding of each transformer in a transformer circuit are connected in a crossed manner, to achieve the same current value for electrical signals that pass through the harmonic circuits. This may alternatively be implemented by connecting a rectifier circuit and a secondary-side winding of each transformer in a transformer circuit in a crossed manner. This is not limited. For a specific connection structure thereof, refer to FIG. 4 and solutions corresponding to FIG. 4. Details are not described herein.

It should be noted that in FIG. 1 to FIG. 3 and FIG. 5 provided in embodiments and solutions corresponding to FIG. 1 to FIG. 3 and FIG. 5 in the embodiments, the rectifier circuits (104, 204, . . . , and N−4) are electrically connected in parallel, to increase a current value of an output electrical signal. Apparently, in solutions corresponding to FIG. 1 to FIG. 7, rectifier circuits (104, 204, . . . , and N−4) may alternatively be electrically connected in series, to increase a voltage value of an output electrical signal.

In a solution of FIG. 4, each rectifier circuit and a secondary-side winding of each transformer are connected in a crossed manner, to implement autonomous current equalization among the harmonic circuits. However, if the rectifier circuits are connected in series, the transformers and the rectifier circuits are equipotential. Therefore, cross-connection between each rectifier circuit and the secondary-side winding of each transformer cannot implement autonomous current equalization among the harmonic circuits. Therefore, in the solution of FIG. 4, the rectifier circuits cannot be electrically connected in series.

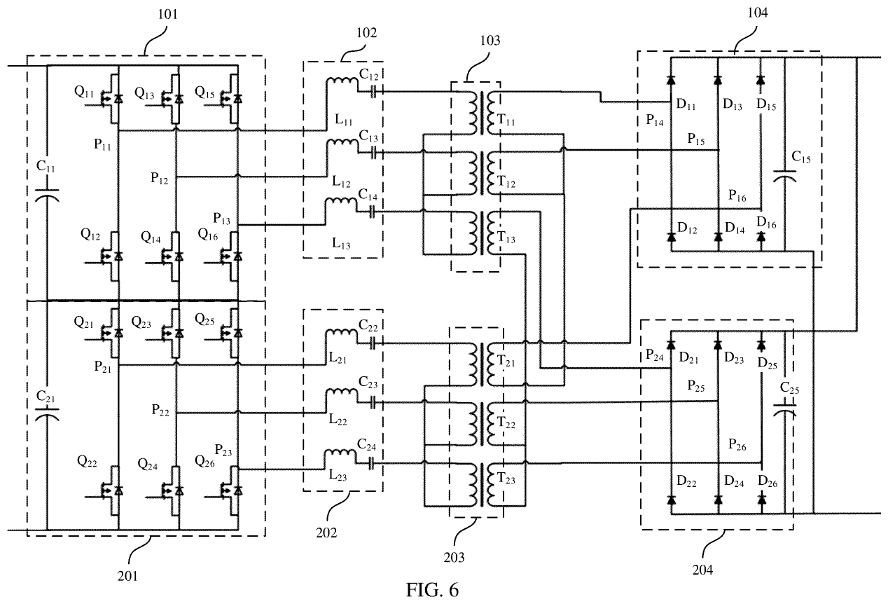

With reference to a two-way three-phase LLC resonant conversion circuit shown in FIG. 6, the circuit includes a first harmonic circuit 100 and a second harmonic circuit 200. The first harmonic circuit 100 includes a first switch circuit 101, a first LC resonant circuit 102, a first transformer circuit 103, and a first rectifier circuit 104. The second harmonic circuit 200 includes a second switch circuit 201, a second LC resonant circuit 202, a second transformer circuit 203, and a second rectifier circuit 204. The first switch circuit 101 and the second switch circuit 201 are connected in series, and the first rectifier circuit 104 and the second rectifier circuit 204 are connected in parallel.

When the first switch circuit 101 and the second switch circuit 201 are connected in series, current values of electrical signals that pass through the first harmonic circuit 100 and the second harmonic circuit 200 are the same. However, voltage values of electrical signals that are input to the first harmonic circuit 100 and the second harmonic circuit 200 may be different, so that resonant parameters of electrical signals that are output by the first rectifier circuit 104 and the second rectifier circuit 204 are different. As a result, an electrical signal that is output by the two-way three-phase LLC resonant conversion circuit cannot provide an electrical signal for a power-consuming device.

In the embodiments, to achieve the same voltage value for the electrical signals that pass through the first harmonic circuit 100 and the second harmonic circuit 200, two rectifier circuits may be connected in a crossed manner to a secondary-side winding of each transformer in two transformer circuits. A specific connection manner is as follows.

In the first transformer circuit 103, one terminal of a transformer T₁₁ is electrically connected to an input port P₁₄ of the first rectifier circuit 104, one terminal of a transformer T₁₂ is electrically connected to an input port P₁₅ of the first rectifier circuit 104, another terminal of the transformer T₁₁ and another terminal of the transformer T₁₂ are electrically connected to each other and electrically connected one terminal of a transformer T₂₁ in the second transformer circuit 203, and one terminal of a transformer T₁₃ is electrically connected to an input port P₂₄ of the second rectifier circuit 204.

In the second transformer circuit 203, another terminal of the transformer T₂₁ is electrically connected to an input port P₁₆ of the first rectifier circuit 104, one terminal of a transformer T₂₂ is electrically connected to an input port P₂₅ of the second rectifier circuit 204, one terminal of a transformer T₂₃ is electrically connected to an output port P₂₃ of the second rectifier circuit 204, and another terminal of the transformer T₂₂ and another terminal of the transformer T₂₃ are electrically connected to each other and are electrically connected to another terminal of the transformer T₁₃ in the first transformer circuit 103.

A connection manner between two rectifier circuits and a primary-side winding of each transformer in two transformer circuits may be a Y-shaped connection manner. An example is described as follows.

In the first transformer circuit 103, one terminal of a transformer T₁₁ is connected in series to a harmonic capacitor C₁₂ in the first LC resonant circuit 102, one terminal of a transformer T₁₂ is connected in series to a harmonic capacitor C₁₃ in the first LC resonant circuit 102, one terminal of a transformer T₁₃ is connected in series to a harmonic capacitor C₁₄ in the first LC resonant circuit 102, and another terminal of the transformer T₁₁, another terminal of the transformer T₁₂, and another terminal of the transformer T₁₃ are electrically connected to each other. In the second transformer circuit 203, one terminal of a transformer T₂₁ is connected in series to a harmonic capacitor C₂₂ in the second LC resonant circuit 202, one terminal of a transformer T₂₂ is connected in series to a harmonic capacitor C₂₃ in the second LC resonant circuit 202, one terminal of a transformer T₂₃ is connected in series to a harmonic capacitor C₂₄ in the second LC resonant circuit 202, and another terminal of the transformer T₂₁, another terminal of the transformer T₂₂, and another terminal of the transformer T₂₃ are electrically connected to each other.

Denote a voltage of a primary-side winding of the transformer T₁₁ as V_{AT11}, a voltage of a secondary-side winding of the transformer T₁₁ as V_{BT11}, a voltage of a primary-side winding of the transformer T₁₂ as V_{AT12}, a voltage of a secondary-side winding of the transformer T₁₂ as V_{BT12}, a voltage of a primary-side winding of the transformer T₁₃ as V_{AT13}, a voltage of a secondary-side winding of the transformer T₁₃ as V_{BT13}, a voltage of a primary-side winding of the transformer T₂₁ as V_{AT21}, a voltage of a secondary-side winding of the transformer T₂₁ as V_{BT21}, a voltage of a primary-side winding of the transformer T₂₂ as V_{AT22}, a voltage of a secondary-side winding of the transformer T₂₂ as V_{BT22}, a voltage of a primary-side winding of the transformer T₂₃ as V_{AT23}, and a voltage of a secondary-side winding of the transformer T₂₃ as V_{BT23}. V_{AT11}, V_{AT12}, and V_{AT13} are of different phases, and V_{AT11} and V_{BT11} are of the same phases. A relationship between other currents is obtained by analogy. Optionally, a phase difference between V_{AT11}, V_{AT12}, and V_{AT13} is 120°.

For secondary-side windings of two transformer circuits, the another terminal of the transformer T₁₁, the another terminal of the transformer T₁₂, and the another terminal of the transformer T₁₃ are electrically connected to each other. Therefore, V_{AT11}=V_{AT12}=V_{AT13}. Similarly, the another terminal of the transformer T₂₁, the another terminal of the transformer T₂₂, and the another terminal of the transformer T₂₃ are electrically connected to each other. Therefore, V_{AT21}=V_{AT22}=V_{AT23}. In addition, V_{AT11}=n·V_{BT11}, V_{AT12}=n·V_{BT12}, V_{AT13}=n·V_{BT13}, V_{AT21}=n·V_{BT21}, V_{AT22}=n·V_{BT22}, and V_{AT23}=n·V_{BT23}. When a quantity of turns of a primary-side winding and that of a secondary-side winding are the same in each transformer, V_{BT11}=V_{BT12}=V_{BT13}=V_{B1}, and V_{BT21}=V_{BT22}=V_{BT23}=V_{B2}.

The transformer T₁₁ and the transformer T₁₂ are electrically connected to each other, and are electrically connected to the transformer T₂₁. Therefore, for the first harmonic circuit 104, an output voltage V₁=\sqrt{6}·V_{BT11}=\sqrt{6}·V_{B1}. Similarly, the transformer T₂₂ and the transformer T₂₃ are electrically connected to each other, and are electrically connected to the transformer T₁₃. Therefore, for the second harmonic circuit 204, an output voltage V₂=\sqrt{6}·V_{BT21}=\sqrt{6}V_{B2}. The voltage value V1 of the first harmonic circuit 100 and the voltage value V2 of the second harmonic circuit 200 are the same, thereby implementing autonomous voltage equalization among the harmonic circuits of the two-way three-phase LLC resonant conversion circuit.

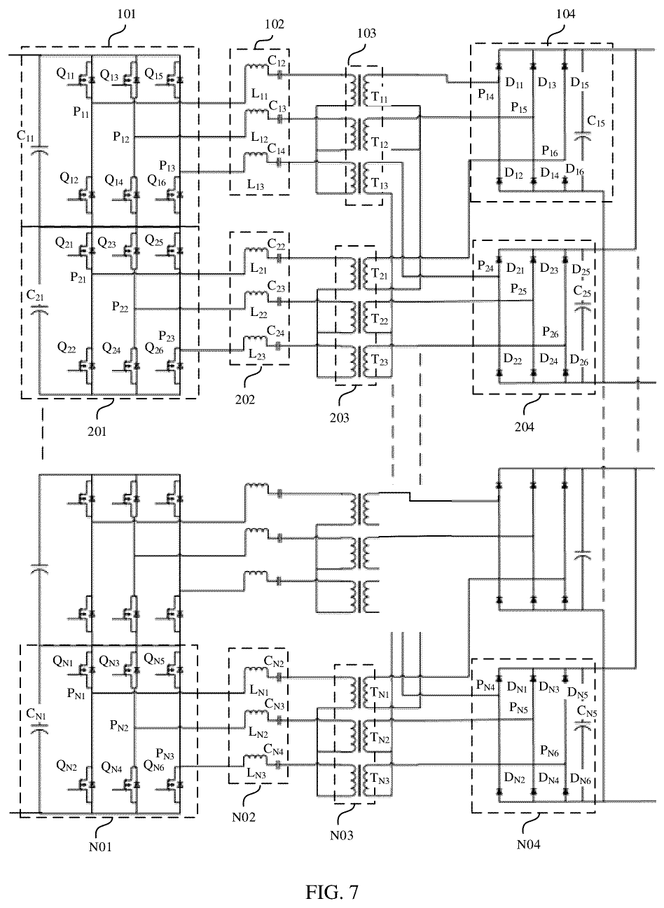

As shown in FIG. 7, an N-way three-phase LLC resonant conversion circuit includes N harmonic circuits (100, 200, . . . , and N00). To achieve the same voltage value for electrical signals that pass through a first harmonic circuit 100 and a second harmonic circuit 200, two rectifier circuits may be connected in a crossed manner to a secondary-side winding of each transformer in two transformer circuits. A specific connection manner is as follows.

In a first transformer circuit 103, one terminal of a transformer T₁₁ is electrically connected to an input port P₁₄ of a first rectifier circuit 104, one terminal of a transformer T₁₂ is electrically connected to an input port P₁₅ of the first rectifier circuit 104, and another terminal of the transformer T₁₁ and another terminal of the transformer T₁₂ are electrically connected to each other and then electrically connected to one terminal of a transformer T₂₁ in a second transformer circuit 203, . . . , and one terminal of a transformer T_{N1} in an Nth transformer circuit N03 in sequence. In this way, for the first harmonic circuit 100, a voltage V₁=\sqrt{6}·V_{BT11}. In the second transformer circuit 203, one terminal of a transformer T₂₂ is electrically connected to an input port P₂₅ of a second rectifier circuit 204, one terminal of a transformer T₂₃ is electrically connected to an input port P₂₆ of the second rectifier circuit 204, and another terminal of the transformer T₂₂ and another terminal of the transformer T₂₃ are electrically connected to each other and then electrically connected to one terminal of a transformer T₁₃ in the first transformer circuit 103, . . . , and one terminal of a transformer T_{N3} in the Nth transformer circuit N03 in sequence. In this way, for the second harmonic circuit 100, a voltage V₂=\sqrt{6}·V_{BT21}=V₁. By analogy, it can be obtained that V₁=V₂= . . . =V_{N}. In other words, voltage values of the harmonic circuits are the same. This can implement autonomous voltage equalization for the harmonic circuits in the N-way three-phase LLC resonant conversion circuit.

In the embodiments, as an example in FIG. 6 and FIG. 7, a connection manner between an LC resonant circuit and a primary-side winding of a transformer is a Y-shaped connection manner. Alternatively, the connection manner may be a Δ-shaped connection manner. This is not limited. For a specific connection structure thereof, refer to FIG. 3 and solutions corresponding to FIG. 3. Details are not described herein again.

An embodiment provides a charging device. The charging device includes an LLC resonant conversion circuit. The LLC resonant conversion circuit may be the LLC resonant conversion circuit recorded in FIG. 1 to FIG. 7 and the corresponding solutions. The charging device includes the LLC resonant conversion circuit. Therefore, the charging device has all or at least some advantages of the LLC resonant conversion circuit. The charging device may be a device such as a charging pile or a charger.

An embodiment provides an energy storage device. The energy storage device includes an LLC resonant conversion circuit and a battery. The LLC resonant conversion circuit is electrically connected to the battery and is configured to process an electrical signal to be input to the battery, and input a processed electrical signal to the battery. The LLC resonant conversion circuit may be the LLC resonant conversion circuit recorded in FIG. 1 to FIG. 7 and the corresponding solutions. The energy storage device includes the LLC resonant conversion circuit. Therefore, the energy storage device has all or at least some advantages of the LLC resonant conversion circuit. The energy storage device may be a lithium battery, a storage battery, or the like.

An embodiment provides a power-consuming device. The power-consuming device includes an LLC resonant conversion circuit and at least one electricity consumption component. The LLC resonant conversion circuit is connected to the at least one electricity consumption component and is configured to process an electrical signal to be input to the at least one electricity consumption component, and input a processed electrical signal to the at least one electricity consumption component. The LLC resonant conversion circuit may be the LLC resonant conversion circuit recorded in FIG. 1 to FIG. 7 and the corresponding solutions. The power-consuming device includes the LLC resonant conversion circuit. Therefore, the power-consuming device has all or at least some advantages of the LLC resonant conversion circuit. The power-consuming device may be an electric vehicle, a base station, a communication device, or the like.

In the embodiments, specific features, structures, materials, or characteristics may be combined in a proper manner in any one or more of embodiments or examples.

It should be noted that the foregoing embodiments are merely intended for describing solutions, but are not limiting. Although described in detail with reference to the foregoing embodiments, persons of ordinary skill in the art should understand that they may still make modifications to the solutions described in the foregoing embodiments or make equivalent replacements to some features thereof, without departing from the scope of the solutions of the embodiments.

What is claimed is:

1. An LLC resonant conversion circuit, comprising:
N resonant circuits, wherein N is a positive integer greater than or equal to 2;
each harmonic circuit comprises a switch circuit, an LC resonant circuit, a transformer circuit, and a rectifier circuit that are electrically connected in sequence, the transformer circuit comprises at least three transformers, and each transformer comprises a first winding and a second winding; and
one terminal of a first winding of each of at least two transformers in a transformer circuit in a first harmonic circuit is electrically connected to an LC resonant circuit in the first harmonic circuit, other terminals of the first windings are electrically connected to each other and are electrically connected to one terminal of a first winding of one transformer in a transformer circuit in another harmonic circuit, and the another harmonic circuit is a harmonic circuit other than the first harmonic circuit among the N harmonic circuits; or
one terminal of a second winding of each of at least two transformers in a transformer circuit in a first harmonic circuit is electrically connected to a rectifier circuit in the first harmonic circuit, and other terminals of the second windings are electrically connected to each other and are electrically connected to one terminal of a second winding of one transformer in a transformer circuit in another harmonic circuit.

2. The LLC resonant conversion circuit according to claim 1, wherein, when the switch circuits in the harmonic circuits are connected in parallel:
one terminal of a first winding of each of at least two transformers in a first transformer circuit is electrically connected to a first LC resonant circuit, other terminals of the first windings of the at least two transformers are electrically connected to each other and are electrically connected to one terminal of a first winding of a first transformer in a second transformer circuit, and still another terminal of the first winding of the first transformer is electrically connected to the first LC resonant circuit;
one terminal of a first winding of each of at least two transformers other than the first transformer in the second transformer circuit is electrically connected to a second LC resonant circuit, other terminals of the first windings of the at least two transformers other than the first transformer in the second transformer circuit are electrically connected to each other and are electrically connected to one terminal of a first winding of a second transformer in the first transformer circuit, and still another terminal of the first winding of the second transformer is electrically connected to the second LC resonant circuit; and
the first harmonic circuit comprises the first LC resonant circuit and the first transformer circuit, the second transformer is a transformer other than the at least two transformers in the first transformer circuit, the another harmonic circuit comprises a second harmonic circuit, and the second harmonic circuit comprises the second LC resonant circuit and the second transformer circuit.

3. The LLC resonant conversion circuit according to claim 2, wherein one terminal of a second winding of each of at least three transformers in the first transformer circuit is electrically connected to a first rectifier circuit, and other terminals of the second windings of the at least three transformers are electrically connected to each other; one terminal of a second winding of each of at least three transformers in the second transformer circuit is electrically connected to a second rectifier circuit, and still other terminals of the second windings of the at least three transformers are electrically connected to each other; and the first harmonic circuit comprises the first rectifier circuit, and the second harmonic circuit comprises the second rectifier circuit.

4. The LLC resonant conversion circuit according to claim 1, wherein the rectifier circuits in the harmonic circuits are connected in series or connected in parallel.

5. The LLC resonant conversion circuit according to claim 1, wherein, when the switch circuits in the harmonic circuits are connected in series or in parallel:
one terminal of a second winding of each of at least two transformers in a first transformer circuit is electrically connected to a first rectifier circuit, other terminals of the second windings of the at least two transformers are electrically connected to each other and are electrically connected to one terminal of a second winding of a first transformer in a second transformer circuit, and still another terminal of the second winding of the first transformer is electrically connected to the first rectifier circuit;
one terminal of a second winding of each of at least two transformers other than the first transformer in the second transformer circuit is electrically connected to a second rectifier circuit, other terminals of the second windings of the at least two transformers other than the first transformer in the second transformer circuit are electrically connected to each other and are electrically connected to one terminal of a second winding of a second transformer in the first transformer circuit, and still another terminal of the second winding of the second transformer is electrically connected to the second rectifier circuit; and
the first harmonic circuit comprises the first transformer circuit and the first rectifier circuit, the second transformer is a transformer other than the at least two transformers in the first transformer circuit, the another harmonic circuit comprises a second harmonic circuit, and the second harmonic circuit comprises the second transformer circuit and the second rectifier circuit.

6. The LLC resonant conversion circuit according to claim 5, wherein one terminal of a first winding of each of at least three transformers in the first transformer circuit is electrically connected to a first LC resonant circuit, and other another terminals of the first windings of the at least three transformers are electrically connected to each other; one terminal of a first winding of each of at least three transformers in the second transformer circuit is electrically connected to a second LC resonant circuit, and still other another terminals of the first windings of the at least three transformers are electrically connected to each other; and the first harmonic circuit comprises the first LC resonant circuit, and the second harmonic circuit comprises the second LC resonant circuit.

7. The LLC resonant conversion circuit according to claim 5, wherein the rectifier circuits in the harmonic circuits are connected in parallel.

8. The circuit according to claim 1, wherein the transformers in the transformer circuits are the same.

9. The LLC resonant conversion circuit according to claim 1, wherein the at least three transformers in each transformer circuit share an iron core.

10. A two-way three-phase LLC resonant conversion circuit, comprising:
a first harmonic circuit and a second harmonic circuit,
the first harmonic circuit comprises a first switch circuit, a first LC resonant circuit, a first transformer circuit, and a first rectifier circuit that are electrically connected in sequence, the second harmonic circuit comprises a second switch circuit, a second LC resonant circuit, a second transformer circuit, and a second rectifier circuit that are electrically connected in sequence, and the first switch circuit and the second switch circuit are connected in series;
each switch circuit comprises three output ports, each LC resonant circuit comprises three resonant inductors and three resonant capacitors, each resonant inductor is connected in series to one resonant capacitor, each transformer circuit comprises three transformers, each transformer comprises a first winding and a second winding, and each rectifier circuit comprises three input ports;
three output ports of the first switch circuit are respectively connected in series to three resonant inductors and three resonant capacitors in the first LC resonant circuit in sequence; each of two of the three resonant capacitors is electrically connected to one terminal of a first winding of one of two of three transformers in the first transformer circuit in a one-to-one correspondence, and other terminals of the first windings of the two of the three transformers in the first transformer circuit are electrically connected to each other and are electrically connected to one terminal of a first winding of one of three transformers in the second transformer circuit; one terminal of a first winding of the other transformer of the three transformers in the first transformer circuit is electrically connected to one of three resonant capacitors in the second LC resonant circuit, and still another terminal of the first winding of the other transformer of the three transformers in the first transformer circuit is electrically connected to one terminal of a first winding of each of the other two of the three transformers in the second transformer circuit;
one terminal of a second winding of each of the three transformers in the first transformer circuit is electrically connected to one of three input ports of the first rectifier circuit in a one-to-one correspondence, and other terminals of the second windings of the three transformers in the first transformer circuit are electrically connected to each other;
three output ports of the second switch circuit are respectively connected in series to three resonant inductors and the three resonant capacitors in the second LC resonant circuit in sequence, and the other two of the three resonant capacitors in the second LC resonant circuit are respectively electrically connected to other terminals of the first windings of the other two of the three transformers in the second transformer circuit; and
one terminal of a second winding of each of the three transformers in the second transformer circuit is electrically connected to one of three input ports of the second rectifier circuit in a one-to-one correspondence, and other terminals of the second windings of the three transformers in the second transformer circuit are electrically connected to each other.

11. A two-way three-phase LLC resonant conversion circuit, comprising:
a first harmonic circuit and a second harmonic circuit,
the first harmonic circuit comprises a first switch circuit, a first LC resonant circuit, a first transformer circuit, and a first rectifier circuit that are electrically connected in sequence, and the second harmonic circuit comprises a second switch circuit, a second LC resonant circuit, a second transformer circuit, and a second rectifier circuit that are electrically connected in sequence;
each switch circuit comprises three output ports, each LC resonant circuit comprises three resonant inductors and three resonant capacitors, each resonant inductor is connected in series to one resonant capacitor, each transformer circuit comprises three transformers, each transformer comprises a first winding and a second winding, and each rectifier circuit comprises three input ports;
three output ports of the first switch circuit are respectively connected in series to three resonant inductors and three resonant capacitors in the first LC resonant circuit in sequence, each of the three resonant capacitors is electrically connected to one terminal of a first winding of one of three transformers in the first transformer circuit in a one-to-one correspondence, and other terminals of the first windings of the three transformers in the first transformer circuit are electrically connected to each other;
one terminal of a second winding of each of two of the three transformers in the first transformer circuit is electrically connected to one of two of three input ports of the first rectifier circuit in a one-to-one correspondence, and other terminals of the second windings of the two of the three transformers in the first transformer circuit are electrically connected to each other and are electrically connected to one terminal of a second winding of one of three transformers in the second transformer circuit; and one terminal of a second winding of the other transformer of the three transformers in the first transformer circuit is electrically connected to one of three input ports of the second rectifier circuit, and still another terminal of the second winding of the other transformer of the three transformers in the first transformer circuit is electrically connected to one terminal of a second winding of each of the other two of the three transformers in the second transformer circuit;
three output ports of the second switch circuit are respectively connected in series to three resonant inductors and three resonant capacitors in the second LC resonant circuit in sequence, each of the three resonant capacitors is electrically connected to one terminal of a first winding of one of the three transformers in the second transformer circuit in a one-to-one correspondence, and other terminals of the first windings of the three transformers in the second transformer circuit are electrically connected to each other; and
another terminal of the second winding of the one of the three transformers in the second transformer circuit is electrically connected to one of the three input ports of the first rectifier circuit, and other terminals of the second windings of the other two of the three transformers in the second transformer circuit are respectively electrically connected to the other two of the three input ports of the second rectifier circuit.

12. An energy storage device, comprising:
a battery; and
at least one LLC resonant conversion circuit according to claim 1, wherein the LLC resonant conversion circuit is electrically connected to the battery and is configured to process an electrical signal to be input to the battery, and input a processed electrical signal to the battery.

13. The energy storage device according to claim 12, wherein when the switch circuits in the harmonic circuits are connected in parallel,
one terminal of a first winding of each of at least two transformers in a first transformer circuit is electrically connected to a first LC resonant circuit, other terminals of the first windings of the at least two transformers are electrically connected to each other and are electrically connected to one terminal of a first winding of a first transformer in a second transformer circuit, and still another terminal of the first winding of the first transformer is electrically connected to the first LC resonant circuit;
one terminal of a first winding of each of at least two transformers other than the first transformer in the second transformer circuit is electrically connected to a second LC resonant circuit, other terminals of the first windings of the at least two transformers other than the first transformer in the second transformer circuit are electrically connected to each other and are electrically connected to one terminal of a first winding of a second transformer in the first transformer circuit, and still another terminal of the first winding of the second transformer is electrically connected to the second LC resonant circuit; and
the first harmonic circuit comprises the first LC resonant circuit and the first transformer circuit, the second transformer is a transformer other than the at least two transformers in the first transformer circuit, the another harmonic circuit comprises a second harmonic circuit, and the second harmonic circuit comprises the second LC resonant circuit and the second transformer circuit.

14. The energy storage device according to claim 13, wherein one terminal of a second winding of each of at least three transformers in the first transformer circuit is electrically connected to a first rectifier circuit, and other terminals of the second windings of the at least three transformers are electrically connected to each other; one terminal of a second winding of each of at least three transformers in the second transformer circuit is electrically connected to a second rectifier circuit, and still other terminals of the second windings of the at least three transformers are electrically connected to each other; and the first harmonic circuit comprises the first rectifier circuit, and the second harmonic circuit comprises the second rectifier circuit.

15. The energy storage device according to claim 12, wherein the rectifier circuits in the harmonic circuits are connected in series or connected in parallel.

16. The energy storage device according to claim 12, wherein when the switch circuits in the harmonic circuits are connected in series or in parallel,
one terminal of a second winding of each of at least two transformers in a first transformer circuit is electrically connected to a first rectifier circuit, other terminals of the second windings of the at least two transformers are electrically connected to each other and are electrically connected to one terminal of a second winding of a first transformer in a second transformer circuit, and another terminal of the second winding of the first transformer is electrically connected to the first rectifier circuit;
one terminal of a second winding of each of at least two transformers other than the first transformer in the second transformer circuit is electrically connected to a second rectifier circuit, other terminals of the second windings of the at least two transformers other than the first transformer in the second transformer circuit are electrically connected to each other and are electrically connected to one terminal of a second winding of a second transformer in the first transformer circuit, and still another terminal of the second winding of the second transformer is electrically connected to the second rectifier circuit; and
the first harmonic circuit comprises the first transformer circuit and the first rectifier circuit, the second transformer is a transformer other than the at least two transformers in the first transformer circuit, the another harmonic circuit comprises a second harmonic circuit, and the second harmonic circuit comprises the second transformer circuit and the second rectifier circuit.

17. The energy storage device according to claim 16, wherein one terminal of a first winding of each of at least three transformers in the first transformer circuit is electrically connected to a first LC resonant circuit, and other terminals of the first windings of the at least three transformers are electrically connected to each other; one terminal of a first winding of each of at least three transformers in the second transformer circuit is electrically connected to a second LC resonant circuit, and other terminals of the first windings of the at least three transformers are electrically connected to each other; and the first harmonic circuit comprises the first LC resonant circuit, and the second harmonic circuit comprises the second LC resonant circuit.

18. The energy storage device according to claim 16, wherein the rectifier circuits in the harmonic circuits are connected in parallel.

19. The energy storage device according to claim 12, wherein the transformers in the transformer circuits are the same.

20. The energy storage device according to claim 12, wherein the at least three transformers in each transformer circuit share an iron core.
